(19) United States
(12) Patent Application Publication
(10) Pub. No.: US 2011/0109869 A1
(43) Pub. Date: May 12, 2011

(54) RECONFIGURABLE WAVELENGTH SELECTIVE CROSS-CONNECT SWITCH USING LIQUID CRYSTAL CELLS

(75) Inventor: FENGHUA LI, Stow, OH (US)

(73) Assignee: CoAdna Photonics, Inc., Sunnyvale, CA (US)

(21) Appl. No.: 12/940,895

(22) Filed: Nov. 5, 2010

Related U.S. Application Data
(60) Provisional application No. 61/259,089, filed on Nov. 6, 2009.

(51) Int. Cl. G02F 1/13; G02F 1/01

(52) U.S. Cl. 349/196; 359/256

(57) ABSTRACT

A reconfigurable optical cross-connect switch includes N input ports and M output ports, where N and M are integers with a value of two or more. The switch has a set of switching stages where each switching stage includes a polarization switch to receive an input linearly polarized optical beam. One or more birefringent prism pairs associated with the polarization switch directs the input linearly polarized optical beam to any of the M output ports through control of the polarization switch.

### CROSS-REFERENCE TO RELATED APPLICATION

This application claims priority to U.S. Provisional Patent Application 61/259,089, filed Nov. 6, 2009, entitled “Reconfigurable Wavelength Selective Cross-Connect Switch Using Liquid Crystal Cells”.

### FIELD OF THE INVENTION

The present invention relates to optical switching. More particularly, the invention relates to a reconfigurable wavelength selective cross-connect switch using liquid crystal cells.

### BACKGROUND OF THE INVENTION

Agile optical networks use dense wave division multiplexing (DWDM) fiber optics to interconnect network nodes to increase transmission capacity over point-to-point links. This is achieved through various control techniques, such as remotely switching traffic to deliver data channels with different wavelengths to the desired destinations, or to add or drop an intended wavelength to/from a desired routing of optical signals. This is known as a “reconfigurable optical add-drop multiplexer (ROADM)”. Typical systems configured today have channels precisely aligned onto an ITU standardized grid at 100 GHz, 50 GHz channel spacing. Also required is the feature of automatic protection switching, which enables a failed channel to be switched instantly to an alternate channel with a then-available wavelength in the event of a failure between network nodes. All-optical switching technologies are therefore becoming more attractive to manage the tremendous bandwidth being transmitted over optical fibers. A Wavelength selective cross-connect (WSXC) is a device that offers such optical switching functions.

A WSXC device normally has N incoming fibres and N outgoing fibres, each fibre being capable of carrying M wavelength channels. The WSXC provides independent switching of each of the M wavelength channels from the N incoming fibres to the N outgoing fibres. It is functionally equivalent to an input array of N wavelength demultiplexers routed to an output array of N wavelength multiplexers through an array of M×N×N optical switches. In such a WSXC, there are M×N×N possible optical paths, which is the required flexibility in the absence of wavelength conversion. For instance, in the case mentioned above of a 96 channel system at 50 GHz spacing with 8 fibers in and 8 fibers out, the standard large optical core based switch would have over a million possible connections, whereas only 6144 are needed, which is exactly what the WSXC architecture enables (96×8×8).

For wavelength-selective optical switching or cross-connect, two commonly employed switching elements are micro-electromechanical mirrors (MEMS) and liquid crystals (LC). These technologies use free space optics: the optical signal is transported from the fiber waveguide, manipulated using unguided optical components and then reinserted into an output fiber waveguide. Waveguided approaches (e.g. planar light circuits or PLCs) have been proposed for such functions but to date their promise has not been realized because of technical problems.

MEMS are constructed using microlithographic techniques. The mirrors are deformed or reoriented using electrostatic forces. Because of their small size and method of fabrication, it is straightforward to produce the arrays of mirrors required for wavelength-selective switching. Also, because the mirrors can take on a range of orientations they are conceptually easy to implement for higher port count wavelength-selective switches. It is the flexibility of the beam steering mechanism that makes MEMS devices so promising and at the same time creates significant challenges for control and long term stability. MEMS devices rely on steering a reflected beam; controlling the angle of reflection is paramount. Small deviations (<0.1 degree) in signal deflection can dramatically increase the coupling losses to an output port. Fabrication of the MEMS arrays requires an expensive processing facility, which makes them a costly solution for low volume applications. Most importantly, the MEMS chip cannot provide a high controllable tilt angle so that high ports switching based on MEMS is difficult.

Liquid crystal (LC) technology has a relatively long history for optical switching applications. Liquid crystals are fluids that derive their anisotropic physical properties from the long range orientational order of their constituent molecules. Liquid crystals exhibit birefringence and the optic axis of a LC fluid can be reoriented by an electric field. This switchable birefringence is the mechanism underlying all applications of liquid crystals to optical switching and attenuation.

Two mechanisms have been proposed in the prior art for optical switching using liquid crystals: polarization modulation and total internal reflection (TIR). Optical switching refers to signal redirection to one of at least two channels (1×M switch; M>1). On/off liquid crystal optical switches can also be constructed on the principle of switchable scattering.

TIR liquid crystal switches rely on the difference in refractive index between the liquid crystal and the confining medium (e.g., glass). By proper choice of materials and angle of incidence of the light at the liquid crystal interface, it is possible to totally internally reflect the light when no field is applied to the liquid crystal. The effective index of the liquid crystal may be changed by reorienting the optic axis of the liquid crystal so that the total internal refection criterion is no longer met; light then passes through the liquid crystal rather than reflecting from the interface. As with other types of reflective devices, such as MEM devices, controlling the reflection angle is critical. Also, since unwanted surface reflections are always present to some degree, crosstalk can be a significant problem.

Polarization modulation is the most common mechanism used in liquid crystal devices for optical switching. Switching is achieved between two orthogonal polarization states: for example, two orthogonal linear polarizations or left and right circular polarization. By way of illustration, a simple prior art liquid crystal polarization modulator is shown in FIG. 1a. A layer of nematic liquid crystal 1 is sandwiched between two transparent substrates 2 and 3. Transparent conducting electrodes 4 and 5 are coated on the inside surfaces of the substrates. The electrodes are connected to a voltage source 6 through an electrical switch 7. Directly adjacent to the liquid crystal surfaces are two alignment layers 8 and 9 (e.g., rubbed polyimide) that provide the surface anchoring required to orient the liquid crystal. The alignment is such that the optic axis of the liquid crystal is substantially the same through the liquid crystal and lies in the plane of the liquid crystal layer when the switch 7 is open.

FIG. 1b schematically depicts the liquid crystal configuration in this case. The optic axis in the liquid crystal 10 is substantially the same everywhere throughout the liquid crystal layer. FIG. 1c shows the variation in optic axis orientation 12 as a result of molecular reorientation that occurs when the switch 7 is closed. The liquid crystal cell as described is known in the field as an electrically controlled birefringence device (or ECB). Such a liquid crystal polarization modulator was described in U.S. Pat. No. 7,499,608 as part of an optical switch/variable optical attenuator (VOA) for fiber optic communications applications. The patent, which is owned by the assignee of the current application, is incorporated herein by reference.

To act as a switch, the modulator must produce two orthogonal polarizations at the exit of the modulator that can then be differentiated with additional optical components. This polarization conversion scheme provides the foundation for a number of electro-optic devices. If a linear polarizer is placed at the exit to the modulator, a simple on/off switch is obtained. If a polarizing beam splitter is placed at the exit, a 1×2 switch can be realized.

It would be desirable to utilize liquid crystal cell technology in sophisticated optical switches, such as a reconfigurable wavelength selective cross-connect switch.

### SUMMARY OF THE INVENTION

A reconfigurable wavelength selective cross-connect switch includes N input ports and M output ports, where N and M are integers with a value of two or more. The switch has a set of switching stages where each switching stage includes a polarization switch to receive an input linearly polarized optical beam. One or more birefringent prism pairs associated with the polarization switch directs the input linearly polarized optical beam to any of the M output ports through control of the polarization switch. The invention reduces the number of components and interconnections typically required in a wavelength selective cross-connect (WSXC).

### BRIEF DESCRIPTION OF THE DRAWINGS

FIG. 1a is a schematic drawing of a prior art electrically-driven liquid crystal cell that may be used as a polarization rotator in an embodiment of the current invention.

FIG. 1b is a schematic illustrating the rotation of the polarization of linearly polarized light by 90° upon passage through the liquid crystal cell of FIG. 1a when no voltage is applied to the cell.

FIG. 1c is a schematic illustrating no rotation of the polarization of incident linearly polarized light upon passage through the liquid crystal cell of FIG. 1a when sufficiently high voltage is applied to the cell.

FIG. 2a illustrates a prior art birefringent wedge whose optic axis is orthogonal to the sides of the wedge.

FIG. 2b illustrates the effect that the wedge has on incoming polarized light. Light polarized parallel to the optic axis is deflected at a larger angle from the direction of the incident beam than light polarized orthogonal to the optic axis.

FIG. 3 is a schematic diagram showing the operating principal of a prior art Wollaston polarizer.

FIG. 4a is a detailed schematic of a single stage of a LC/Wollaston polarizer assembly. A vertically polarized incident beam is converted to horizontally polarized light by the LC cell in its low voltage state and is subsequently deflected upwards by the Wollaston polarizer. The optic axis of the wedges is oriented as in FIG. 3 so that the polarization of the light is parallel to the optic axis of the first wedge.

FIG. 4b is the same as FIG. 4a except that the LC cell is in its high voltage state and the polarization of the incident light is unchanged by the cell. In this case, the polarization of the beam passing through the Wollaston polarizer is perpendicular to the optic axis of the first wedge and the beam is deflected downwards.

FIG. 5a is a side view of a prior art structure for converting an arbitrarily polarized beam from an optical fiber into two parallel beams with identical polarization.

FIG. 5b is an end-on view of the prior art structure of FIG. 5a showing the orientation of the optic axis of the half wave plate used to convert the polarization of the extraordinary ray to that of the ordinary ray.

FIG. 6a is a side view of a polarization-independent embodiment of the current invention using a Wollaston polarizer where the input beam received from input port 1 has polarization in the vertical direction.

FIG. 6b is a side view of a polarization-independent embodiment of the current invention using a Wollaston polarizer where the input beam received from input port 1 has polarization in the horizontal direction.

FIG. 6c is a side view of a polarization-independent embodiment of the current invention using a Wollaston polarizer where the input beam received from input port 2 has polarization in the horizontal direction.

FIG. 6d is a side view of a polarization-independent embodiment of the current invention using a Wollaston polarizer where the input beam received from input port 2 has polarization in the vertical direction.

FIG. 7 is a schematic illustration of a 3×3 WSXC based on a 2×2 WSXC.

FIG. 8 is a schematic illustration of a 4×4 WSXC based on a 2×2 WSXC.

FIG. 9 is a schematic illustration of a 4×4 WSXC configured in accordance with an embodiment of the invention.

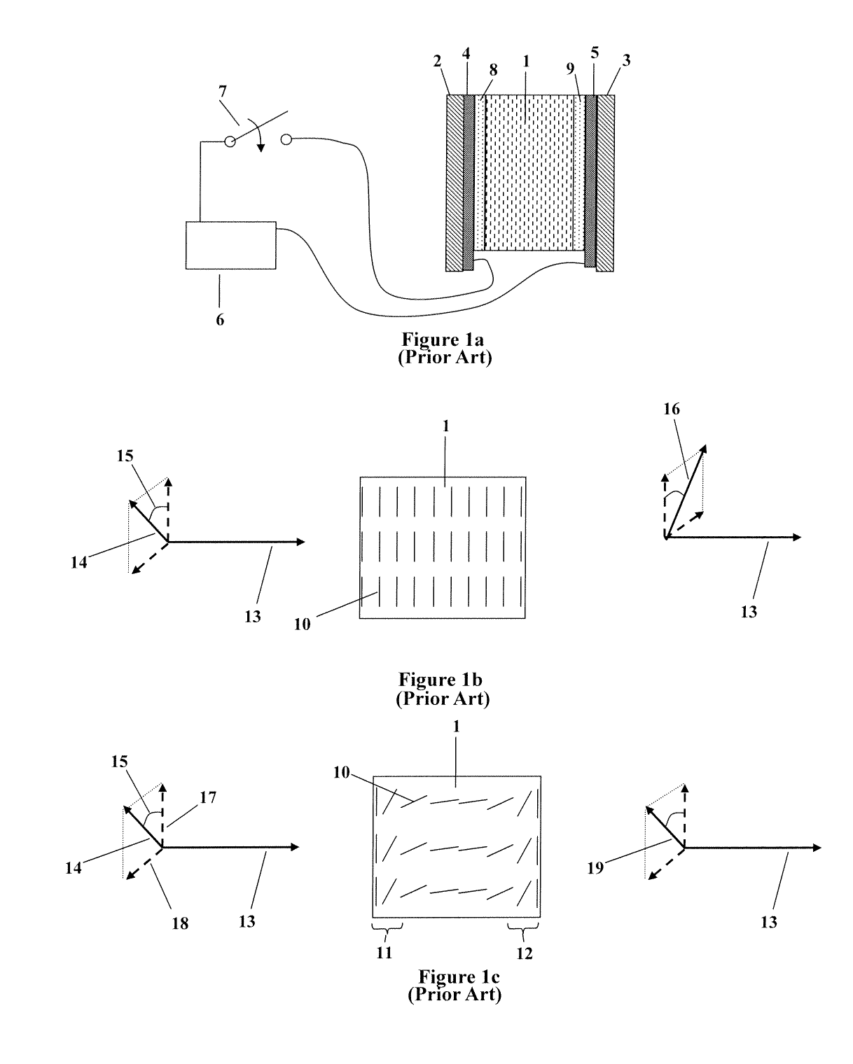

### DETAILED DESCRIPTION OF THE INVENTION

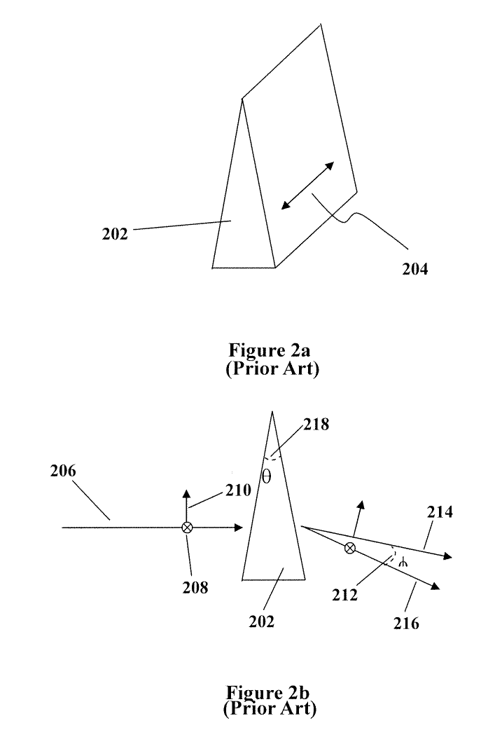

FIG. 2a is a perspective view a birefringent wedge 202. In this figure, the optic axis of the birefringent material is indicated with arrow 204 as lying in the horizontal plane when the apex of the wedge points vertically. That is, it is parallel to the vertex edge of the wedge. It is not a requirement of this invention that the optic axis be so oriented, but it is chosen for illustrative purposes in elucidating an embodiment of the invention. FIG. 2b illustrates the impact that such a birefringent wedge has on a beam of polarized light passing through it. If the incident beam 206 has polarization 208 parallel to the optic axis (i.e., an extraordinary ray), the action of the wedge is to deflect the beam away from the vertex upon exit. The deflection angle depends substantially linearly on the extraordinary index of refraction, nₑ, of the wedge and the wedge angle θ. On the other hand, if the incident beam has polarization 210 orthogonal to the optic axis (i.e., an ordinary ray), the deflection angle upon exit will depend on the ordinary index, n, and consequently there will be an angular difference φ 212 between the ordinary 214 and extraordinary rays 216 upon exiting the wedge. This separation angle φ depends substantially linearly on the wedge angle θ 218 and the birefringence, nₑ−nₒ, of the wedge. Of course, if the input polarization is a combination of both polarizations, the input beam will be partially diverted into both exit directions. This is not desirable for a switch application where the beam should be routed into either one or the other of the two directions. FIG. 2b presumes that the extraordinary index of the wedge is greater than the ordinary index (nₑ>nₒ) resulting in a greater deflection of the extraordinary ray. If nₒ>nₑ, then the ordinary ray will have the greater deflection. To avoid confusion, all examples and embodiments assume that nₑ>nₒ, but note that this is not a requirement of the invention.

Finally, observe that both the e-ray and o-ray are deflected away from the birefringent wedge vertex and not symmetrically with respect to the input beam direction. If the wedges are all oriented the same, upon passage through successive stages of the switch, the deflected beams will be steered further from the input beam direction. This may be undesirable for certain switch geometries, and in particular, is extremely detrimental to the design of a 1×M wavelength switch. This problem can be mitigated in a few ways. One simple way to lessen the deflection for more than one stage is to alternate the orientation of the wedges so that the vertices point in opposite directions. This will lessen the deflection, but cannot produce M beams uniformly distributed about the incident direction. Another mechanism that can produce such a uniform distribution is a wedge made of isotropic material.

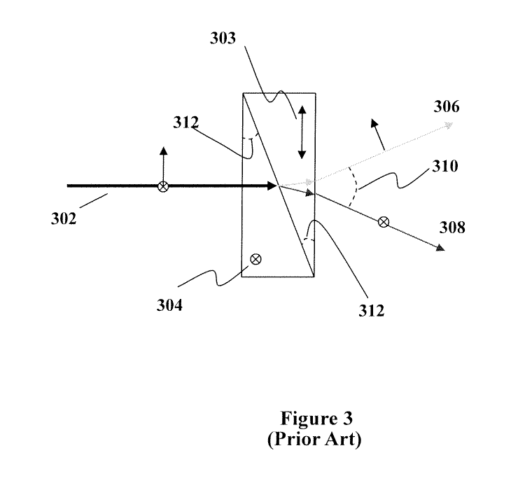

A third approach is to replace a birefringent wedge with a birefringent wedge pair whose optic axes 302 and 303 are orthogonal as illustrated in FIG. 3. This configuration is known in the art as a Wollaston polarizer. It has the property that for a normally incident beam 304, the beam is split into two orthogonally polarized beams 306 and 308 whose deviations are symmetric with respect to the incident direction of propagation. To obtain the same angular deviation φ 310 between the two beams as is achieved in the single wedge case, the wedge angle 312 for each member of the Wollaston pair should be half of that for the single wedge design.

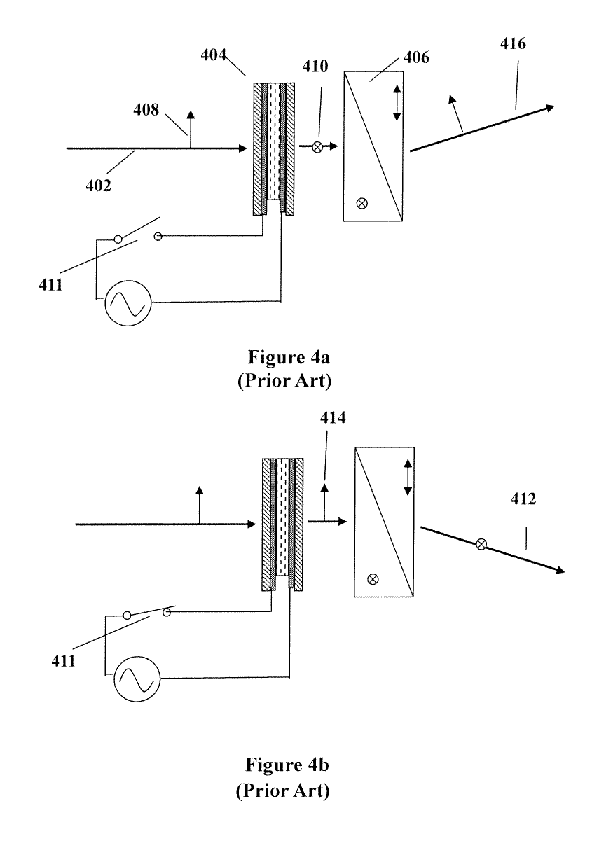

FIGS. 4a and 4b illustrate the operation of the first stage of the LC/Wollaston pair assembly of FIG. 3. The wedge is presumed to have the same optic axis orientation as in FIG. 2 with nₑ>nₒ. Referring to FIG. 4a, a beam of light is incident from the left on the LC switching cell 404. The incident beam 402 is linearly polarized in the vertical direction 408. Upon passing through the LC switch cell 404 in its low voltage state (electrical switch 411 open), the polarization 410 is rotated 90° so that it passes through the birefringent wedge 406 as an extraordinary ray and is deflected accordingly. Referring now to FIG. 4b, the same incident beam is passed through the LC cell, here in its high voltage state (electrical switch 411 closed). In this case, the beam experiences no polarization change and passes through the wedge as an ordinary ray and is deflected through a smaller angle than for the low voltage state of the LC. Hence, LC Switch 404 and Birefringent Wedge 406 produce two possible output directions 412 and 416 for the incident beam as indicated in FIGS. 4a and 4b respectively. Each of these output beams can be steered into two further directions by the action of a second LC Switch and a second Birefringent Wedge, resulting in 4 possible beam propagation directions after the second stage of the assembly. Continuing in similar fashion, for an assembly of M stages, there are 2^{M} possible output propagation directions for the exit beam.

This preceding discussion gives a conceptual overview of components of the invention, but ignores some significant details that are necessary to produce a useful device for routing or wavelength selective switching in a DWDM fiber optic network.

In a fiber optic network, the light does not have a controlled polarization. This results from polarization modification by optical components in the system (e.g., optical amplifiers, gain equalizers, attenuators) as well as ubiquitous form and strain birefringence in the fiber itself. Hence, the LC/wedge assembly described above is useless in such a network unless a means is provided to achieve a well-defined, controlled polarization for the optical beam prior to entering the switch assembly. This is a common problem for which solutions have been described in the prior art.

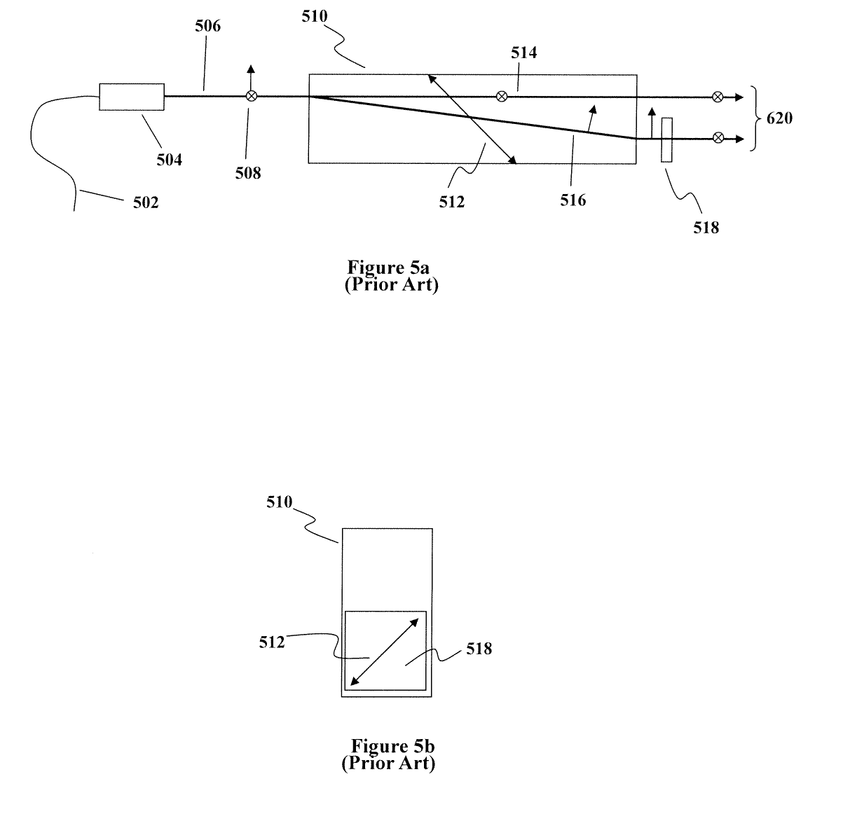

FIGS. 5a and 5b illustrate perhaps the most widely used means to address this problem. Referring to FIG. 5a, light exits an optical fiber 502 and passes through a system with optical power (a collimator) 504 which collimates the light into a beam 506 of arbitrary polarization 508. This beam is passed through a birefringent crystal 510 of sufficient length and proper optic axis orientation 512 to separate the ordinary 514 and extraordinary 516 beams sufficiently so that they do not overlap at the exit surface of the crystal. In such an application, the birefringent crystal is known to those familiar with the art as a beam displacer (BD) or a walkoff crystal. One of the beams 516 is then passed through a half wave retardation plate 518, which rotates the beam's polarization by 90° so that there are two parallel beams 620 with identical and well-defined linear polarization. FIG. 5b is an end view of the crystal showing the orientation of the optic axis of the half wave retardation plate, which produces the desired 90° rotation of polarization for the optical system as presented in FIG. 5a. This scheme operates also in reverse so that two parallel beams of identical polarization can be combined and coupled into an optical fiber using the same configuration of elements. Henceforth, the optical assembly as shown in FIGS. 5a and 5b and described above shall be referred to as a fiber coupling assembly, whether it be at the input or output of a fiber.

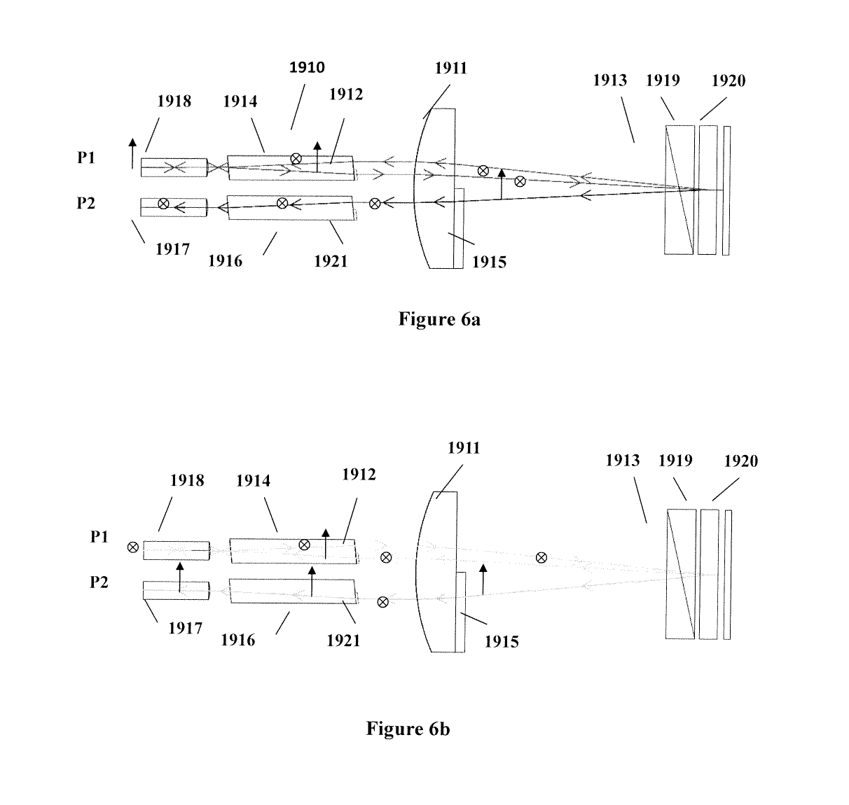

Operation of the wavelength cross-connect shown in FIG. 6a is illustrated without spectrum elements for ease of illustration. The wavelength cross-connect 1910 is shown having two input ports that also operate as two output ports. Each of the input/outputs transmits an optical signal corresponding to a selected wavelength. A spectrum element may be used to separate a selected wavelength. Alternately, a dispersive element, such as a grating between a beam displacer and a lens may be used for wavelength selection.

A collimated beam of light at collimator 1918 having a predetermined polarization along a vertical direction and carrying one wavelength channel is launched from input P1. The beam is transmitted inside beam displacer BD 1914 downwards and is rotated. The polarization is into the horizontal direction after the half waveplate 1912. The beam is then transmitted to the lens 1911 and the Wollaston pair 1913, and focuses at mirror 1920. If the LC cell 1919 has an applied high voltage, the beam is reflected back to the Wollaston pair 1913 with horizontal polarization. Then the beam goes back to the same BD 1914 with the opposite polarization compared with the initial input beam. In this design, the beam goes through the BD's 1914 desired upper part and the collimator 1918 collects the beam with excellent insertion loss. If the LC cell 1919 has an applied appropriate voltage, the beam changes the polarization 90 degrees and becomes vertical. In order to have the same efficiency at the polarization-dependent spectrum element, a half waveplate 1915 is placed at the lower half of the lens 1911. Now the beam rotates its polarization into the horizontal direction and hits the BD's 1916 upper part. This results in excellent insertion loss at the collimator 1917. The port separation between two BDs is mainly controlled by the focal length of the lens 1911 and the angle of the birefringent wedge of the Wollaston pair.

Referring to FIG. 6b, a collimated beam of light at collimator 1918 has a predetermined polarization along the horizontal direction and carries one channel wavelength launched from input P1. The beam is transmitted inside BD 1914 upwards. The beam is then transmitted to the lens 1911 and the Wollaston pair 1913, and is focused at mirror 1920. If the LC cell 1919 has high voltage, the beam is reflected back to the Wollaston pair 1913 with the same horizontal polarization. Then the beam returns to the same BD 1914 with the opposite polarization compared to the initial input beam. The half waveplate 1912 rotates the polarization into a vertical orientation. The beam goes through the BD's 1914 desired lower part and collimator 1918 collects the beam with excellent insertion loss. If the LC cell 1919 is applied appropriate voltage, the beam changes polarization 90 degrees and becomes vertical when it goes back to the Wollaston pair 1913. In order to have the same efficiency at the polarization-dependent spectrum element, a half waveplate 1915 is placed at the lower half of the lens 1911. Now the beam rotates its polarization into the horizontal direction and hits the BD's 1916 lower part and goes through the half waveplate 1921. This results in excellent insertion loss at the collimator 1917.

Referring to FIG. 6c, a collimated beam of light at collimator 1917 has a predetermined polarization along the vertical direction and carries one wavelength channel from input P2. The beam is transmitted inside BD 1916 downwards and its polarization is rotated into the horizontal direction after the half waveplate 1921. The beam is then transmitted to the lens 1911 and its polarization is rotated into vertical polarization by the half waveplate 1915. Then the beam goes through the Wollaston pair 1913 and focuses at mirror 1920. If the LC cell 1919 has high voltage, the beam is reflected back to the Wollaston pair 1913 with the same vertical polarization. Then the beam goes back to the half waveplate 1915, which rotates the polarization into the horizontal direction again. The beam then goes back to the same BD 1916 with the opposite polarization of the initial input beam. Observe that the beam goes through the BD's 1916 desired upper part and collimator 1917 collects the beam with excellent insertion loss. If the LC cell 1919 is applied an appropriate voltage, the beam changes the polarization 90 degrees and becomes horizontal when it goes back to the Wollaston pair 1913. Now the beam rotates its polarization into the horizontal direction and hits the BD 1914's upper part. Again, this results in excellent insertion loss at the collimator 1918.

In FIG. 6d, a collimated beam of light at collimator 1917 has a predetermined polarization along the horizontal direction and carries one channel launched from input P2. The beam is transmitted inside BD 1916 upwards. The beam is then transmitted to the lens 1911 and goes through the half waveplate with polarization converted to the vertical. The beam continues through the Wollaston pair 1913, and focuses at mirror 1920. If the LC cell 1919 has high voltage, the beam is reflected back to the Wollaston pair 1913 with the same vertical polarization. Then the beam goes back to the half waveplate 1915 and rotates the polarization into the horizontal direction again. The beam goes back to the same BD 1916 with the opposite polarization compared with the initial input beam. The beam goes through the BD 1916's desired lower part and changes the polarization into the vertical direction after the half waveplate 1921. The collimator 1917 collects the beam with excellent insertion loss. The LC cell 1919 may receive an appropriate voltage so that the beam changes the polarization 90 degrees and becomes horizontal when it goes back to the Wollaston pair 1913. Now the beam rotates its polarization into the horizontal direction and hits the BD 1914's lower part and changes the polarization into the vertical direction after the half waveplate 1912. This results in excellent insertion loss at the collimator 1918.

It will be appreciated that by using the above method, a 1×2 or 2×1 switch can be formed. Also, by adding more blocks of Wollaston pairs and more LC cells, a 1×N or N×1 switch can be constructed.

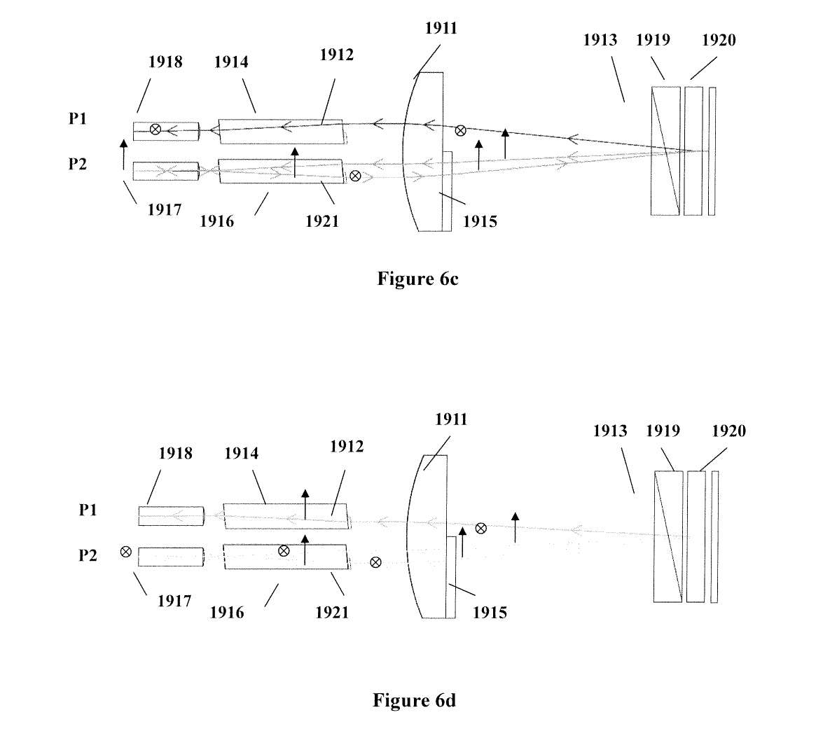

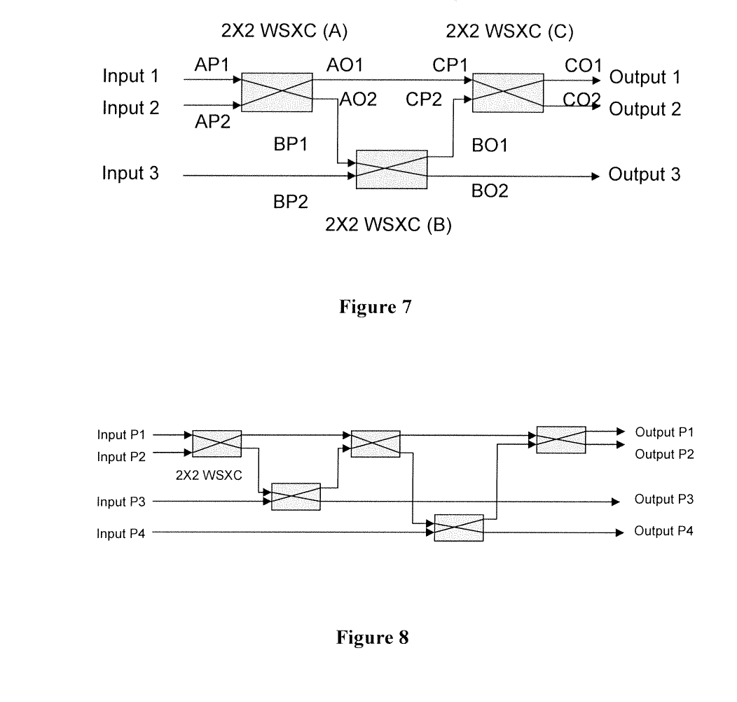

The current invention can be expanded to construct WSXC devices with an increased number of input ports which form the building blocks of complex optical network and routing systems. The operation of an embodiment of a 3×3 WSXC is illustrated schematically in FIG. 7, in which it comprises three 2×2 WSXCs (A, B, C). Each 2×2 WSXC is a device as described in FIGS. 6 (a), (b), (c), (d). Each 2×2 WSXC has two input ports that also operate as two output ports. For example, if the beam is to be routed from input port 1 to output 2, the beam is routed from input AP1 of 2×2 WSXC(A) to output AO2 of 2×2 WSXC(A), then from input BP1 of 2×2 WSXC(B) to its output BO1. The signal is then routed to input CP2 of 2×2 WSXC(C), which directs it to its output CO2. If the beam is to be routed from input port 3 to output 1, the beam is routed from input BP2 of 2×2 WSXC(B) to output BO1 of 2×2 WSXC(B), then from input CP2 of 2×2 WSXC(C) to its output CO1. Thus, any beam with any wavelength from any input fiber port of 3 inputs can be routed into any output port of three outputs. In order to construct a 4×4 WSXC, five 2×2 WSXC are used, which is illustrated schematically in FIG. 8. Similarly, any beam with any wavelength from any input fiber port of 4 input ports can be routed into any output port of four outputs. Due to the structure of a 3×3 switch and a 4×4 switch in the current invention, some configurations have the beam going through more than one WSXC, which results in worse insertion loss compared with a 2×2 WSXC. However, 2×2 WSXC's insertion loss is excellent, typically 3 dB-4 dB, so the 3×3 and 4×4 WSXC might still have quite good insertion loss. A 3×3 or 4×4 WSXC can be constructed in stacked form in one box, which does not have a high cost.

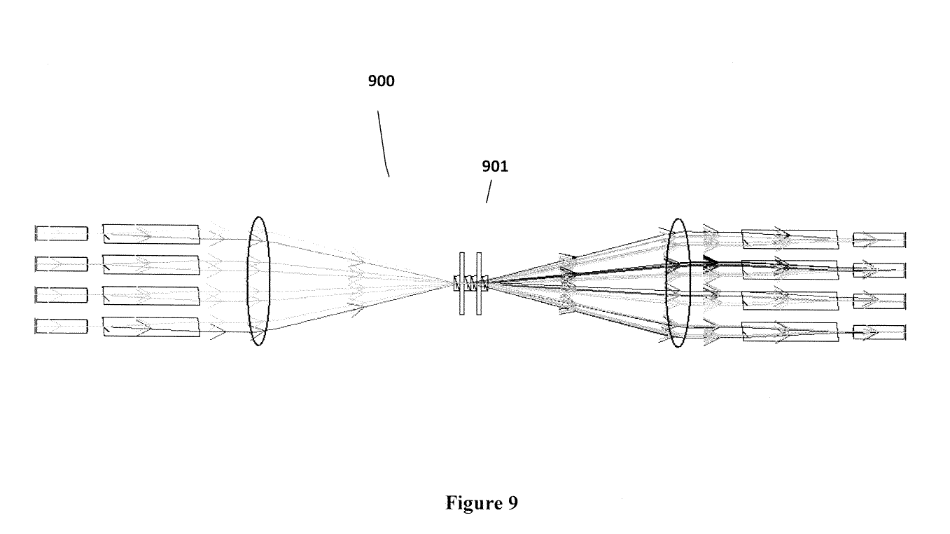

FIG. 9. shows another embodiment of a 4×4 wavelength cross-connect without spectrum elements for ease of illustration. In the WSXC device 900, each of the 4 input ports can deliver a signal to any of the 4 output ports. The optical path can be chosen and controlled by the LC controlling assembly 901 constructed with two Wollaston pairs and two LC cells. Based on different choices of polarization for all 4 inputs, there are a total of 32 different optical paths. The operation is similar to the operations described in connection with FIGS. 6 (a), (b), (c), (d). A beneficial feature of this embodiment, compared with the examples in FIG. 7 and FIG. 8, is that the insertion loss is much better since there are no cascading 2×2 WSXCs. Adding another Wollaston pair and one LC cell, one can implement 4×8 or 8×8 devices.

Thus, the invention contributes to the realization of a N×M WSXC where N and M are integers with a value of 2 of more. N and M are not necessarily equal to each other. Another beneficial feature of the invention is that the optical structure eliminates unnecessary combinations of through switching paths in order to provide cross-connect capability, thus reducing the number of WSSs or WSXCs used and the interconnections between them.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. An optical cross-connect switch, comprising:
N input ports to receive unpolarized input optical beams, where N is an integer with a value of two or more;
a plurality of switching stages where each switching stage includes:
a polarization switch to receive an input linearly polarized optical beam,
one or more birefringent prism pairs associated with the polarization switch to direct the input linearly polarized optical beam to one of two output locations through control of the polarization switch; and
an output stage with M ports, the output stage directing an output optical beam to one of the M ports, where M is an integer with a value of two or more.

2. The optical cross-connect switch of claim 1 wherein each polarization switch utilizes liquid crystal as an active medium.

3. The optical cross-connect switch of claim 2 wherein each polarization switch is controlled by an electric field.

4. The optical cross-connect switch of claim 1 in combination with means for producing parallel collimated linearly polarized beams corresponding to the input linearly polarized optical beams.

5. The optical cross-connect switch of claim 1 wherein wedge angles of the birefringent prism pair produce output optical beams separated in a plane.

6. The optical cross-connect switch of claim 1 in combination with a dispersion device to spatially separate an input linearly polarized optical beam into individual wavelength channels that are directed to independently addressable regions of at least one polarization switch for wavelength selective switching.

7. The optical cross-connect switch of claim 6 wherein the individual wavelength channels are directed to the independently addressable regions with an optical power device.
